(19) United States
(12) Patent Application Publication
(10) Pub. No.: US 2012/0066105 A1
(43) Pub. Date: Mar. 15, 2012

(54) ENROLLMENT FOR ELECTRONIC BANKING SERVICES

(75) Inventor: Darryl S. O'Neill, Waterloo (CA)

(73) Assignee: NCR CORPORATION, Duluth, GA (US)

(21) Appl. No.: 12/880,212

(22) Filed: Sep. 13, 2010

(51) Int. Cl. G06Q 40/00

(52) U.S. Cl. 705/35

(57) ABSTRACT

A method of enrolment for electronic banking services is described. The method involves receiving a transmitted image (or images) of a financial document. The method further comprises: locating banking information from a portion of the image and performing optical character recognition to extract the located banking information. The method also includes locating customer name and customer address information from another portion of the image and performing optical character recognition to extract a customer name and customer address from the located customer name and customer address information. The method uses this extracted banking and/or customer information to enroll the customer for electronic banking services.

### FIELD OF INVENTION

The present invention relates to a method of enrolment for electronic banking services.

### BACKGROUND OF INVENTION

Registering a bank account for electronic banking services, such as electronic deposits or electronic payments, is typically performed by a financial institution requesting a customer wishing to register to send a void check. The financial institution extracts information from this void check (account number and bank number) and uses the extracted information to enroll that customer.

It would be desirable to make this process quicker, easier, and/or more efficient.

### SUMMARY OF INVENTION

Accordingly, the invention generally provides methods, systems, apparatus, and software for enrolling for electronic banking services.

In addition to the Summary of Invention provided above and the subject matter disclosed below in the Detailed Description, the following paragraphs of this section are intended to provide further basis for alternative claim language for possible use during prosecution of this application, if required. If this application is granted, some aspects may relate to claims added during prosecution of this application, other aspects may relate to claims deleted during prosecution, other aspects may relate to subject matter never claimed. Furthermore, the various aspects detailed hereinafter are independent of each other, except where stated otherwise. Any claim corresponding to one aspect should not be construed as incorporating any element or feature of the other aspects unless explicitly stated in that claim.

According to a first aspect there is provided a method of enrolment for electronic banking services, the method comprising:

receiving a transmitted image of a blank check;

locating banking information from a portion of the image containing a magnetic ink character recognition line;

performing optical character recognition to extract the located banking information;

locating customer name and customer address information from another portion of the image;

performing optical character recognition to extract a customer name and customer address from the located customer name and customer address information; and

using this extracted information to enroll the customer for electronic banking services.

The method may comprise the further step of analyzing additional portions of the image to ensure that these additional portions are blank. The additional portions may correspond to one or more of the corresponding fields on a check, such as: a payee field, a courtesy amount field, a legal amount field, and a signature field.

The method may comprise the further step of adding the word “VOID” to the image as a watermark.

The method may comprise the further step of storing the image on a server as proof of enrolment.

The method may comprise the further step of providing electronic access to the image to bank staff to verify information that was extracted automatically.

Once enrolled in electronic banking, the customer may then have access to (i) automated withdrawals to pay utility bills, magazine subscriptions, and the like, and/or (ii) automated deposits, such has income tax refunds, pay check deposits, and the like.

This method of enrolment for electronic banking services may be used by a customer to register a check relating to a third party account. For example, a customer may wish to register a payroll check with a check cashing company. The check cashing company may allow the customer to enroll for this service by capturing and transmitting an image of the payroll check.

According to a second aspect there is provided a cellular telephone program for enrolling for electronic banking services, the program being operable to: (i) control a camera in the telephone to capture an image of a financial document, (ii) access an electronic address of an organization with which the user of the telephone desires to enroll for electronic banking services, and (iii) transmit the captured image to the received electronic address.

The financial document may comprise a check, an account statement, a utility bill, or the like

Where the financial document is a check, the cellular telephone program may also be operable to validate that the captured check image meets an acceptance criterion. The acceptance criterion may relate to one or more of: image quality, orientation of the check image, a minimum and/or maximum margin around the check, absence of writing or printing in predefined fields (such as payee fields), and the like.

The cellular telephone program may be operable to manipulate a captured image into a defined format. This manipulation may involve cropping the captured image, rotating the captured image, or the like.

The cellular telephone program may be operable to capture an image of the front of the check and an image of the rear of the check, and to create a message including both front and rear images.

The cellular telephone program may be operable to perform OCR of certain fields on the front image. OCR may be performed on one or more of the following fields: MICR (magnetic ink character recognition) codeline, courtesy amount, legal amount, customer address, customer name, or the like.

The cellular telephone program may access an electronic address of an organization with which the user of the telephone desires to enroll for electronic banking services by: accessing a pre-stored address, by prompting the user of the telephone to enter an electronic address, or in any other convenient way.

The cellular telephone program may be downloadable from a Web site operated by the organization with which the user of the telephone desires to enroll for electronic banking services.

The electronic address may comprise a uniform resource locator (URL), an electronic mail address, or the like.

According to a third aspect there is provided a processor implemented method of enrolling a customer for electronic banking services, the method comprising:

controlling a camera to capture an image of a check,

receiving an electronic address of an organization with which the customer desires to enroll for electronic banking services, and

transmitting the captured check to the received electronic address.

The electronic address may be received from the customer (who may type in the electronic address) or may be received from another computer application.

The step of controlling a camera to capture an image of a check may include the sub-steps of capturing an image of the front of the check and an image of the rear of the check, and creating a message including both front and rear images.

The method may include the further step of validating that the captured check image (or images) meets an acceptance criterion.

The method may include the further step of manipulating the captured image (or images) into a defined format.

According to a fourth aspect there is provided an enrolment system for electronic banking services, the system comprising:

a cellular telephone including a cellular telephone program according to the second aspect; and

an enrolment server operable to receive a transmitted message from the cellular telephone program, where the transmitted message includes a check image, and to enroll a customer for electronic banking services based on information extracted from that check image.

The information may be extracted from the check image (or check images, if a front and rear image of the check is required) either by the cellular telephone program or by the enrolment server.

According to a fifth aspect there is provided a method of enrolment for electronic banking, the method comprising:

receiving a transmitted image of a customer statement;

locating banking information from a portion of the image;

performing optical character recognition to extract the located banking information;

locating customer name and customer address information from another portion of the image;

performing optical character recognition to extract a customer name and customer address from the located customer name and customer address information; and

using this extracted information to enroll the customer in electronic banking.

This method may be useful where a customer wants to use a remittance transaction as the basis for enrolment.

According to a sixth aspect there is provided a method of enrolment for electronic banking, the method comprising:

receiving a transmitted image of a financial document;

locating banking information from a portion of the image;

performing optical character recognition to extract the located banking information;

locating customer name and customer address information from another portion of the image;

performing optical character recognition to extract a customer name and customer address from the located customer name and customer address information; and

using this extracted information to enroll the customer in electronic banking.

The financial document may comprise a check, an account statement, remittance advice, an invoice, or the like.

As used herein, a blank check relates to a check that either has no writing on it, or is marked void, or marked in some other way to indicate that it cannot (or can no longer) be used for making a payment.

For clarity and simplicity of description, not all combinations of elements provided in the aspects recited above have been set forth expressly. Notwithstanding this, the skilled person will directly and unambiguously recognize that unless it is not technically possible, or it is explicitly stated to the contrary, the consistory clauses referring to one aspect are intended to apply mutatis mutandis as optional features of every other aspect to which those consistory clauses could possibly relate.

These and other aspects will be apparent from the following specific description, given by way of example, with reference to the accompanying drawings.

### BRIEF DESCRIPTION OF THE DRAWINGS

FIG. 1 is a schematic diagram of an electronic banking enrolment system according to one embodiment of the present invention;

FIG. 2 is a simplified block diagram illustrating one part (a cellular telephone) of the system of FIG. 1 in more detail;

FIG. 3 is a flowchart illustrating steps performed by the cellular telephone of FIG. 2 in enrolling for electronic banking services using the system of FIG. 1;

FIG. 4 is a pictorial diagram of a blank check used by a customer to enroll for banking services using the system of FIG. 1; and

FIG. 5 is a flowchart illustrating steps performed by a part (an enrolment server) of the electronic banking enrolment system of FIG. 1 in response to the steps performed in FIG. 3 by the cellular telephone.

### DETAILED DESCRIPTION

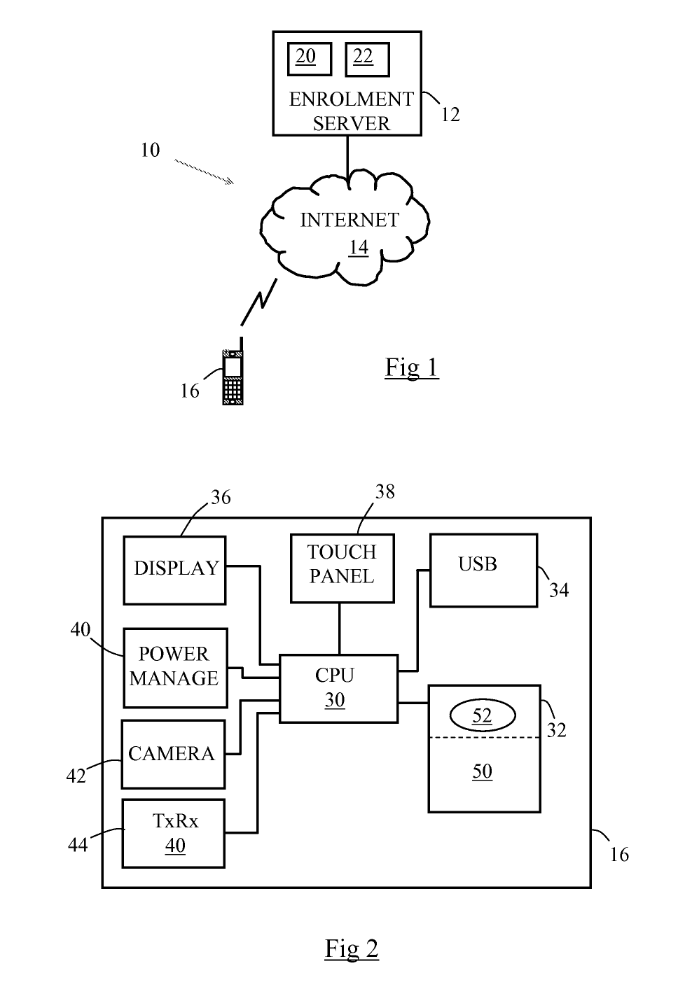

Reference is first made to FIG. 1, which is a schematic diagram of an electronic banking enrolment system 10 according to one embodiment of the present invention.

The enrolment system 10 comprises an enrolment server 12 coupled to the Internet 14. As will be known to those of skill in the art, various Internet-enabled computer devices (such as laptop computers, desktop computers, and handheld computers) could be coupled to the Internet 14. In FIG. 1, a cellular radiofrequency telephone (hereinafter “cell phone”) 16 is shown coupled to the Internet 14.

The enrolment server 12 comprises a message handling component 20, and a back-office interface 22.

The message handling component 20 is operable to extract information from received messages and store images extracted from received messages, as will be described in more detail below.

The back-office interface 22 is operable to access account records relating to customers and to update these account records, for example, by activating a field that enrolls the customer for one or more electronic banking services, as will be described in more detail below. These electronic banking services include remote deposit capture of checks and electronic payments.

Reference will also be made to FIG. 2, which is a simplified block diagram illustrating the cell phone 16 in more detail.

The cell phone 16 comprises one or more processors 30, non-volatile memory 32, a communications interface 34 (including a USB port), a display 36 and associated touch sensitive panel 38, a power management circuit 40 (including a battery and a connection for a batter recharger), a camera 42, and a cellular transceiver 44 (including an antenna). All of these components are conventional cell phone components. The cell phone 16 also includes firmware 50 (in non-volatile memory 32) for controlling these components (such as the camera 42, the display 36, the touch sensitive panel 38, and the like). However, the cell phone 16 also includes an enrolment program 52, which is used by a customer (typically the owner of the cell phone 16) for enrolling in electronic banking services. The enrolment program 52 may have been downloaded from a Web site associated with an organization that provides electronic banking services.

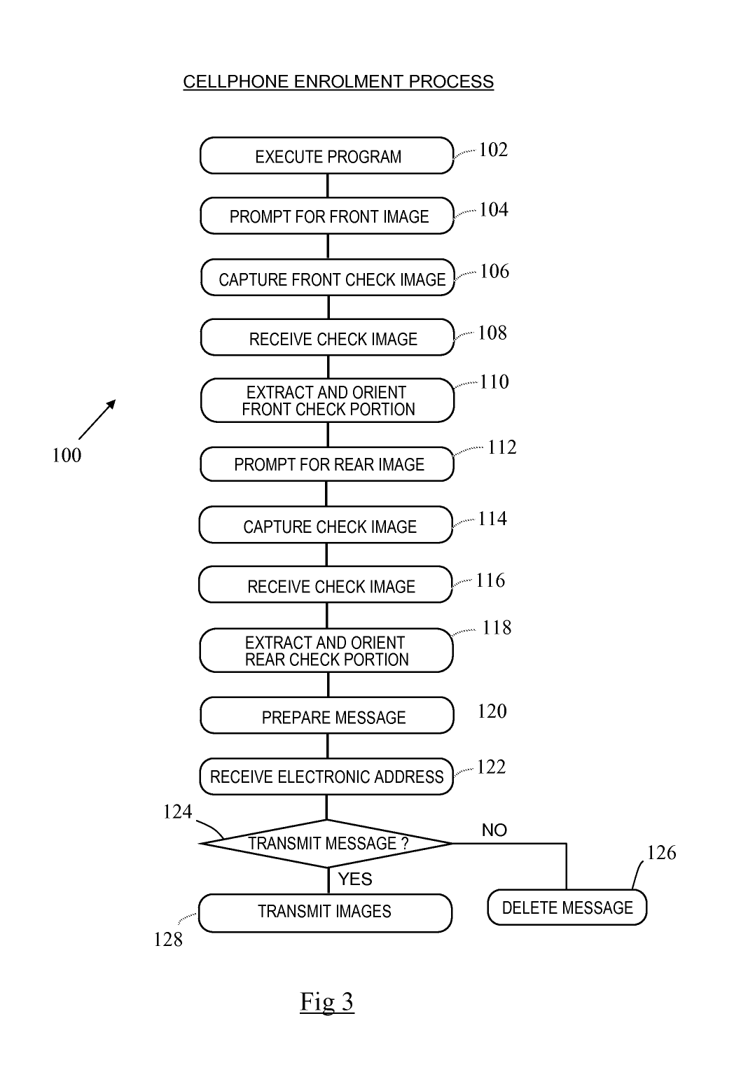

The operation of the cell phone 16 will now be described with reference to FIG. 3, which is a flowchart 100 illustrating steps involved in enrolling for electronic banking services using the enrolment system 10.

Initially, the customer launches the enrolment program 52, which may be presented as an icon on the display 36. This causes the enrolment program 52 to execute (step 102).

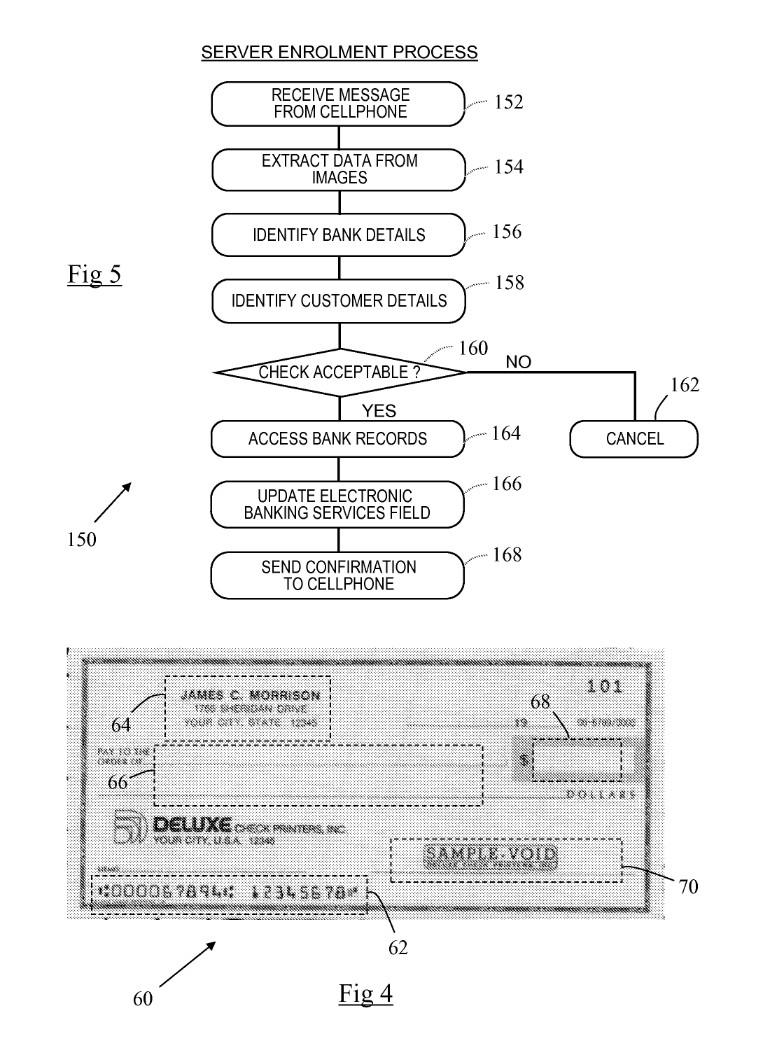

The enrolment program 52 then prompts the customer to capture an image of the front of a check using the camera 42 (step 104). FIG. 4 illustrates a front surface of a typical check 60.

The customer then operates the camera 42 to capture an image (step 106) which is transferred to the enrolment program 52 (step 108).

The enrolment program 52 then extracts the front check image from the image captured by the camera 42 and correctly orients the front check image (step 110). Software is available that can perform this extraction and orientation function. For example, suitable software is described in U.S. patent application 2010/0150424 to Grigori Nepomniachtchi and James DeBello, assigned to Mitek Systems. Suitable software for this function is also available from Mitek Systems Inc, 8911 Balboa Ave., Suite B, San Diego Calif. 92123.

The enrolment program 52 then prompts the customer to capture an image of the rear of a check using the camera 42 (step 112).

The customer then operates the camera 42 to capture an image of the rear of the check (step 114) which is transferred to the enrolment program 52 (step 116).

The enrolment program 52 then extracts the rear check image from the image captured by the camera 42 and correctly orients the rear check image (step 118).

The enrolment program 52 then prepares a message including the front check image and the rear check image (both of which have been extracted and correctly oriented) (step 120).

The enrolment program 52 then prompts the customer to enter an electronic address to which the check images should be sent, which the enrolment program 52 receives (step 122). In this example, the electronic address received from the customer relates to a URL for the enrolment server 12.

The enrolment program 52 then informs the customer that the message is ready for transmission, and requests the customer to confirm that the message should be sent (step 124).

If the customer cancels at this point, then the enrolment program 52 deletes the prepared message (step 126) and closes.

If the customer confirms that the message should be transmitted, then the enrolment program 52 transmits the message to the electronic address received from the customer (step 128), that is, the URL for the enrolment server 12.

Reference will now be made to FIG. 5, which is a flowchart 150 illustrating the steps performed by the enrolment server 12 on receipt of the message from the cell phone 16.

Initially, the message handling component 20 within the enrolment server 12 receives the message transmitted by the cell phone 16 (step 152).

The message handling component 20 then identifies the front and back images from the message and extracts relevant information from these images (step 154). Referring again to FIG. 4, the front check image 60 includes a MICR field 62 comprising banking information (including a bank account number and a bank number); a customer field 64 comprising customer information (including customer name and customer address); a legal amount field 66; a courtesy amount field 68; and a signature field 70. The rear check image (not shown) includes an endorsement field (not shown).

The message handling component 20 identifies the bank account number and bank number using optical character recognition (OCR) on the MICR field 62 (step 156).

The message handling component 20 also identifies the customer name and customer address using OCR on the customer field 64 (step 158).

The message handling component 20 then validates that the check meets an acceptance criterion (step 160). In this example, this involves the message handling component 20 validating that the legal amount field 66 and the customer amount field 68 are blank.

If the check does not meet the acceptance criterion then the message handling component 20 cancels the transaction (step 162) and sends a message to the cell phone 16 indicating that the transaction could not proceed because the check did not meet certain requirements.

If the check does meet the acceptance criterion then the message handling component 20 accesses the banks customer account records via the back-office interface 22 using the customer name and bank account information (step 164).

The message handling component 20 then updates an electronic banking services field (not shown) in the accessed customer account record to enroll that customer in electronic banking (step 166). Optionally, the message handling component 20 may store the front and rear check images in a data store for accessing by staff and/or the customer.

The message handling component 20 then sends a message to the cell phone 16 to confirm that the customer has been enrolled in electronic banking services (step 168).

It will now be appreciated that this process provides a simple and efficient mechanism for allowing a customer to enroll in electronic banking services.

Various modifications may be made to the above described embodiment within the scope of the invention, for example, in other embodiments, the customer may enroll using a previously cashed check that is marked void. In such embodiments, the message handling component 20 implements an acceptance criterion (in step 160) that allows previously cashed checks to be used.

In other embodiments, the check may be issued by a third party and may be used to enroll for check cashing.

In other embodiments, a financial document other than a check, for example, a bank statement, a utility bill, or other remittance may be used to enroll for electronic banking services instead of a check.

In other embodiments, the enrolment program 52 may perform the bank information and customer detail extraction instead of, or in addition to, the message handling component 20.

In other embodiments, the enrolment server may add the word “Void” to the front image of the check.

In other embodiments, the enrolment program 52 may perform part or all of the data extraction from the images that was performed by the enrolment server 12 in the above embodiment (step 154 to 158).

The steps of the methods described herein may be carried out in any suitable order, or simultaneously where appropriate. The methods described herein may be performed by software in machine readable form on a tangible storage medium or as a propagating signal.

The terms “comprising”, “including”, “incorporating”, and “having” are used herein to recite an open-ended list of one or more elements or steps, not a closed list. When such terms are used, those elements or steps recited in the list are not exclusive of other elements or steps that may be added to the list.

Unless otherwise indicated by the context, the terms “a” and “an” are used herein to denote at least one of the elements, integers, steps, features, operations, or components mentioned thereafter, but do not exclude additional elements, integers, steps, features, operations, or components.

The presence of broadening words and phrases such as “one or more,” “at least,” “but not limited to” or other similar phrases in some instances does not mean, and should not be construed as meaning, that the narrower case is intended or required in instances where such broadening phrases are not used.

What is claimed is:

1. A method of enrolment for electronic banking services, the method comprising:
receiving a transmitted image of a blank check;
locating banking information from a portion of the image containing a magnetic ink character recognition line;
performing optical character recognition to extract the located banking information;
locating customer name and customer address information from another portion of the image;
performing optical character recognition to extract a customer name and customer address from the located customer name and customer address information; and
using this extracted information to enroll the customer for electronic banking services.

2. A method according to claim 1, wherein the method comprises the further step of analyzing additional portions of the image to ensure that these additional portions meet an acceptance criterion.

3. A method according to claim 2, wherein the acceptance criterion comprises the additional portion being blank.

4. A method according to claim 1, wherein the method comprises the further step of adding the word “VOID” to the image as a watermark.

5. A method according to claim 1, wherein the method comprises the further step of storing the image on a server as proof of enrolment.

6. A method according to claim 5, wherein the method comprises the further step of providing electronic access to the image to bank staff to verify information that was extracted automatically.

7. A method according to claim 1, wherein the method of enrolment for electronic banking services is used by a customer to register a check relating to a third party account.

8. A cellular telephone program for enrolling for electronic banking services, the program being operable to:
(i) control a camera in the telephone to capture an image of a financial document,
(ii) access an electronic address of an organization with which the user of the telephone desires to enroll for electronic banking services, and
(iii) transmit the captured image to the received electronic address.

9. A cellular telephone program according to claim 8, wherein the program is operable to validate that the captured image meets an acceptance criterion.

10. A cellular telephone program according to claim 9, wherein the acceptance criterion relates to one or more of: image quality, orientation of the image, a minimum and/or maximum margin around the imaged financial document, and absence of writing or printing in predefined fields.

11. A cellular telephone program according to claim 9, wherein the program is operable to manipulate a captured image into a defined format.

12. A cellular telephone program according to claim 8, wherein the program is operable to capture an image of the front of the financial document and an image of the rear of the financial document, and to create a message including both front and rear images.

13. A cellular telephone program according to claim 8, wherein the electronic address comprises a uniform resource locator (URL).

14. A processor implemented method of enrolling a customer for electronic banking services, the method comprising:
controlling a camera to capture an image of a check,
receiving an electronic address of an organization with which the customer desires to enroll for electronic banking services, and
transmitting the captured check to the received electronic address.

15. A processor implemented method according to claim 14, wherein the electronic address is received from the customer.
